(19) United States
(12) Patent Application Publication
(10) Pub. No.: US 2018/0146064 A1
(43) Pub. Date: May 24, 2018

(54) CONTEXTUAL RECOMMENDATION OF CONNECTED MEMBER PROFILES

(71) Applicant: LinkedIn Corporation, Sunnyvale, CA (US)

(72) Inventor: Krishnaram Kenthapadi, Sunnyvale, CA (US)

(21) Appl. No.: 15/359,361

(22) Filed: Nov. 22, 2016

(51) Int. Cl. H04L 29/08; G06Q 10/10

(52) U.S. Cl. CPC H04L 67/306; G06Q 50/01; H04L 67/22; G06Q 10/105

(57) ABSTRACT

A member recommendation system is provided with an on-line social network system. The member recommendation system detects that an electronic presentation is being presented on a display device of a user, determines skills that are being discussed in the electronic presentation, and determines member profiles representing those connections of a user that have been identified as associated with one or more skills discussed in the electronic presentation. References to one or more of the determined member profiles are recommended to the user of the electronic presentation.

### TECHNICAL FIELD

This application relates to the technical fields of software and/or hardware technology and, in one example embodiment, to system and method to identify connected member profiles that are relevant with respect to skills discussed in an electronic presentation.

### BACKGROUND

An electronic presentation (e.g., a slideshow produced using presentation software such as PowerPoint or a web-based slide-hosting service such as SlideShare) is a useful means for sharing information with colleagues, associates, and the public at large. The information being shared may include various concepts scientific, technical, etc. —that are being referenced but not discussed in much detail due to the time constraints that limits the amount of information that can be reasonably imparted by a presentation. At times, a user who is in the process of authoring or editing a presentation may benefit from the existing knowledge of others during the editing or authoring session, e.g., of people who are connected to the user in an on-line social network.

An on-line social network is a platform for connecting people in virtual space. An on-line social network may be a web-based platform, such as, e.g., a social networking web site, and may be accessed by a user via a web browser or via a mobile application provided on a mobile phone, a tablet, etc. An on-line social network may be a business-focused social network that is designed specifically for the business community, where registered members establish and document networks of people they know and trust professionally. Each registered member is represented by a member profile. A member profile is represented by one or more web pages, or a structured representation of the member's information in XML (Extensible Markup Language), JSON (JavaScript Object Notation) or similar format. A member's profile web page of a social networking web site may emphasize employment history and professional skills of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to identify connected relevant member profiles for an electronic presentation may be implemented;

FIG. 2 is block diagram of a system to identify connected relevant member profiles for an electronic presentation, in accordance with one example embodiment;

FIG. 3 is a flowchart illustrating a method to identify connected relevant member profiles for an electronic presentation, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to identify connected member profiles that are relevant with respect to skills discussed in an electronic presentation is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

As mentioned above, a user who is in the process of authoring or editing a presentation may benefit from the existing knowledge of others, especially co-workers, during the editing or authoring of an electronic presentation. It may be beneficial to automatically determine which skills are being referenced in the presentation that is being edited from a computer system associated with a particular company, determine one or more company connections who are familiar with the skills discussed in the presentation, and display references to such connections to the editor/author of the presentation, as a recommendation. References to the recommended connections that may have expertize with one or more skills mentioned in the presentation may be presented as associated with a particular section of the presentation and/or at the beginning or at the end of the presentation. A skill, for the purposes of this description, is an item of information that represents a skill of a member in an on-line social network system and that is stored in a skills database maintained by the on-line social network system. Each skill-related entry in the skills database includes a phrase (e.g., “programming” or “patent prosecution”) that can appear in a member profile maintained by the on-line social network system in one or more designated profile sections, such as, e.g., in the skills and endorsements section of a profile.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network. The profile information of a social network member may include various information such as, e.g., the name of a member, current and previous geographic location of a member, current and previous employment information of a member, information related to education of a member, information about professional accomplishments of a member, publications, patents, etc. As mentioned above, the profile information of a social network member may also include information about the member's professional skills.

In one embodiment, the system to identify connected relevant member profiles for an electronic presentation is implemented as a so-called member recommendation system that is provided as part of or associated with the on-line social network system. The member recommendation system detects that a user is engaged in an editing session with respect to an electronic presentation at a computer system associated with a company. For the purposes of this description, references to “electronic presentation” and “presentation” are to be understood to include any electronic document that can be edited or authored on a computer system. The term “company” is used to indicate any organization that has connections, or volunteers, or contractors, etc. The member recommendation system then determines which skills are being discussed in the presentation (a set of skills), selects member profiles of connections that have been identified as associated with one or more of these skills. The selected member profiles are referred to as a candidate set of user connections. A profile in the candidate set of user connections represents the associated connection in the on-line social network system. The member recommendation system presents to the user references to at least some of those member profiles. For example, the member recommendation system may generate additional user interface including a presentation of references to member profiles of connections that have one or more skills discussed in the presentation with an invitation to contact those connections. An example additional user interface may include information about a recommended connection, such as, e.g., name, title, phone number and e-mail address, availability, etc.

In one embodiment, the member recommendation system generates a candidate set of user connections by selecting, from profiles maintained in the on-line social network system, those member profiles that include a link indicating that that profile is connected with the member profile representing the user who is engaged in the editing session with respect to the electronic presentation and that also lists, in the skills section of the member profile, a skill from the set of skills associated with the electronic presentation or its section. Then, for each item in the candidate set of user connections, the member recommendation system generates a relevance score that reflects how familiar the connection is with a skill discussed in the presentation. The candidate set of user connections that have one or more skills discussed in the presentation section i may be referred to as a candidate set of connections and notated as V(i). It will be noted that the entire presentation can be treated as one section, in which case the presentation section i corresponds to the entire presentation.

The member recommendation system can be configured to generate the relevance scores. The items in the candidate set of user connections are then ranked based on the respective associated relevance values, and those connections that have been assigned the highest relevance scores are selected as being most relevant and therefore can be included in the so-called presentation set of connections. References to connections included in the presentation set of connections are recommended to the user of the presentation.

A relevance value may be generated for an item in a set of connections with respect to an associated skill based on the importance of the skill with respect to the presentation or its section, based on the measure of familiarity of the connection with the skill, as well as based on the availability and proximity of the connection as related to the user who is engaged in the editing session.

Availability of a connection (represented by an item in a set of connections) can either be explicitly captured using the connection preference indicated in a profile representing the connection, or implicitly interred based on how often the connection responded to recent requests by other users. The proximity of a connection as related to the user who is engaged in the editing session can be captured based on the organizational hierarchy of the company, and other corporate graph information. For example, the proximity can be computed as a function of the following factors: tree distance between respective nodes representing the connection and the user in a corporate graph representing the organizational hierarchy of the company. The proximity can also be calculated by taking into account any discussion groups that are common to the connection and the user, extent of communication (e.g., email, instant messaging, etc.) between the connection and the user, as well as the extent of co-viewership and/or co-authorship of corporate documents by the connection and the user.

A relevance score may be generated for a connection with respect to skills discussed in the entire presentation or with respect to skills discussed in a section of a presentation, e.g., for skills discussed in a particular slide in an electronic slideshow presentation. In some embodiments, the member recommendation system generates, for a connection, separate relevance scores for separate sections of a presentation and then aggregates those separate relevance scores to generate the final relevance score for the connection, which is to be treated as indicating relevance of the connection to skills discussed in the entire presentation.

Equation (1) below is an example of calculating the relevance score of a connection v with respect to all combined sections i in a presentation D.

$$relscore ( v ) = {\sum }_{i ∈ D}^{ } relscore ( v , i ) \times significance ( i ) \qquad Equation ( 1 )$$

where different sections i in a presentation D are assigned different significance values significance (i). A significance value for a section in a presentation may be assigned based on various predetermined criteria, such as, e.g., the positioning of a section within the document, the hierarchy of the presentation, etc. Some example methodologies for calculating relevance score for a connection with respect to a section in a presentation are described below.

In one embodiment, in order to generate relevance score for a connection with respect to a section in a presentation the member recommendation system first selects a set of most important skills discussed in a presentation section. The skills detected in a presentation section may be identified as most important skills based on their respective importance scores. The importance score for a skill c in a presentation section i may be notated as impscore (c, i) and may be determined using any of the approaches described further below. The member recommendation system maintains or has access to an inverted index of skill-to-connection mappings (also referred to as an inverted index of skills), where, for a connection v and a skill c, a mapping entry in the inverted index is in the form of:

skill (c)→List of (connection (v), significance score sigscore (c, v)),

where the significance score is a value assigned to a connection/skill pair to indicate the familiarity of the connection v with the skill c. The inverted index of skill-to-connection mappings can be ordered by decreasing significance scores.

The significance score for a connection/skill pair may be determined by constructing a connection skills graph for a connection, based on the member profile representing the connection in the on-line social network system, with nodes representing respective skills of the subject connection. The member recommendation system then applies a graph analysis algorithm, such as, e.g., PageRank, to generate the centrality score for each skill c that is present in the member profile representing the connection v. The centrality score for a skill c with respect to a connection v is notated as phi (c, v). The centrality score phi (c, v) can be used as the significance score. In some embodiments, the significance score sigscore (c, v) can be calculated using the centrality score phi (c, v) together with a so-called endorsement score, which is notated as endsvore (c, v). The endorsement score for a skill c with respect to a connection v can be calculated based on the number of endorsements for the skill c and also based on data reflecting how authoritative the associated endorsers are. The authoritativeness of an endorser may be determined by constructing a connectedness graph for the connection, where the nodes represent the connection and the connection's connections in the on-line social network system, and using a graph analysis technique to determine the importance/authoritativeness of any given node. The significance score of a connection v in the candidate set of connections V(i) corresponding to the skills search query for the section i can be calculated using Equation (2) shown below.

sigscore(c,v) =f(phi(c,v),endscore(c,v)), Equation (2)

where f(.,.) is a monotonically increasing function of two variables, such as, e.g., f(x,y)=xy, or f(x,y)=x′exp(y).

The significance scores calculated for connections with respect to skills are normalized across all connections from the candidate set of user connections.

Returning to the discussion of generating the relevance score for a connection with respect to a section in a presentation, after having identified the skills that are being discussed in or that are associated with a presentation section, the member recommendation system forms a search query consisting of the most important skills in the presentation section i and queries the inverted index of skill-to-connection mappings. Based on the result of the query, the member recommendation system generates the candidate set V(i) of connections corresponding to the skills search query for the section i. The member recommendation system then performs aggregation of the skill-connection significance scores sigscore (c, v) and section-skill importance scores impscore (c, i) in order to rank the retrieved connections. The relevance score for a connection v in the candidate set V(i) of connections corresponding to the skills search query for the section i can be calculated using Equation (3) shown below.

relscore(v,i)=h({((impscore(c,i),sigscore(c, v))|cϵC(i)}), Equation (3)

where h is an aggregation function. For example, relscore (v, i) can be calculated as the sum of products of the importance score of a skill c with respect to the section i, impscore (c, i) and the significance score for a connection v with respect to skill c, sigscore (c, v), for all skills c in the set of skills C(i), using Equation (4) below.

$$relscore ( v , i ) = {\sum }_{c ∈ C}^{ } impscore ( c , i ) \times sigscore ( c , v ) \qquad Equation ( 4 )$$

In some embodiments, the significance score for a connection v with respect to skill c, sigscore (c, v), is binary; that is, it indicated that the connection either possesses a certain skill or not. In this scenario, the relevance value for a connection is generated based on the combined importance of all skills that are associated with the connection in the inverted index of skill-to-connection mappings.

In some embodiments, the importance score of a skill c with respect to the section i, impscore (c, i), is binary; that is, a skill is associated with (discussed or referenced in) the section i, or not. In this scenario, the relevance value for a connection v is generated based on the significance scores sigscore (c, v) associated with those skills that have been identified as most important for section i in the presentation and possessed the connection.

In some embodiments, the significance score for a connection v for imparting the skill c, sigscore (c, v), is not used. In this scenario, if the skills in the inverted index of skill-to-connection mappings are ordered by decreasing significance scores sigscore (c, v), the member recommendation system could use the ordering in the inverted index to rank the connections. In this case, the connections could be ranked by rank aggregation across the important skills, for example, using Borda Count method.

As mentioned above, the member recommendation system selects a so-called presentation set of connections based on the respective relevance values generated for the connections in the candidate set of user connections. For example, the presentation set of connections may include a certain number connections that have the top ranks with respect to the section in the presentation. In another example, the presentation set of connections includes those connections from the candidate set that have relevance values greater or equal to a predetermined threshold. References from the set of connections presentation set of connections are exposed to the user at the time the user is viewing the associated section of the presentation.

In some embodiments, the member recommendation system may be configured to generate contextual connection recommendations: as the user transitions from one presentation section to another, the associated presentation set of connection recommendations is generated or accessed, where the connections to be recommended as relevant to the currently viewed section of the presentation are determined using one of the methodologies discussed above. The member recommendation system may also be configured to detect if the user interacted with the presented reference to a recommended connection (e.g., if the user clicked on the connection recommendation) and to omit presentation of a reference to that connection in any of the subsequently presented sections.

As explained above, the member recommendation system, in the process of determining the relevance of a connection with respect to a presentation or with respect to a section of a presentation, may utilize the importance value of a skill c with respect to a presentation section i. This importance value notated above as impscore (c, i). Some example methodologies for generating the importance score of a skill with respect to a presentation section are described below.

In one embodiment, a so-called skills detector system may be used to determine which skills are referenced in an electronic presentation and to also generate respective importance scores of the determined skills as related to the presentation. The skills detector system is provided as part of or associated with the on-line social network system. The skills detector system is configured to determine which skills referenced in the presentation and may also be configured also determine respective importance scores of the determined skills as related to the presentation. In order to identify a phrase that appears in a presentation as representing a skill, the skills detector system determines whether the phrase is included in the skills database maintained by the on-line social network system. Respective importance scores of the determined skills may be generated as described below.

The skills detector system, according to some embodiments, is configured to construct a skills graph for a presentation, with nodes representing respective skills and edges being assigned a weight value that represent the degree of relatedness of the respective two skills represented by the two connecting nodes. For example, the two skills “patent prosecution” and “patent drafting” have a greater degree of relatedness than, e.g., the two skills “patent prosecution” and “landscape design.” The skills detector system may be configured to assign a value between “0” and “1” to an edge in a skills graph, e.g., with the greater value assigned to an edge indicating the greater degree of relatedness of the respective two skills represented by the two connecting nodes. Each section of a presentation is thus represented as part of a skills graph. A section in a presentation may correspond to a slide (as in a PowerPoint or a SlideShare presentation), or to a portion of a document included in a chapter or under a headings.

Where the skills detector system generates a skills graph for a presentation, it can calculate a so-called centrality score for each node of the skills graph (and thus for each detected skill). Respective centrality scores for the nodes in the skills graph may be determined by applying a graph analysis algorithm, such as, e.g., PageRank. The centrality score for a skill c in a presentation section i is notated as alpha (c, i).

The skills detector system also associates each skill detected in a presentation with a so-called document structure score, which can be determined by examining the structure in the presentation. For example, a skill represented by a phrase that occurs in the title of the presentation is assigned a larger document structure score than a skill identified by a phrase that occurs only in the body of the presentation. As another example, a skill represented by a phrase that is found under one of the top-level bullets is assigned a higher document structure score than a phrase representing a skill is found under one of the lower-level bullets. The document structure score for a skill c in a presentation section i is notated as beta (c, i).

Where the skills detector system e ates a skills graph and, for each detected skill generated a respective document structure score, the importance score for a skill c in a presentation section i is calculated based on the associated centrality score alpha (c, i) and the associated document structure score beta (c, i), using Equation (5) below. Thus calculated importance score is notated as gamma (c, i).

gamma(c,i)=f(alpha(c,i),beta(c, i)), Equation (5)

where f(.,.) is a monotonically increasing function of two variables, such as, e.g., f(x,y)=xy, or f(x,y)=x′exp(y).

In some embodiments, the skills detector system s configured to represent each section in a presentation as a feature vector in high-dimensional space. Some examples of dimensions, in addition to the skill dimension, are title, level in the document structure hierarchy, emphasis in the text presentation (e.g., whether the phrase representing a skill is highlighted, bold, italicized, etc.), occurrence of the skill in previous sections, and occurrence of the skill in subsequent sections. The skills detector system utilizes machine learning techniques to learn a statistical model for calculating the predicted importance score delta (c, i) for a skill c in a presentation section i. The learned model takes, as input, a matrix with skills detected in the presentation section i as rows and features related to the document section (e.g., title, level, emphasis) as columns. The ground truth consists of sections together with the labeled set of important skills.

In some embodiments, the approaches described above for calculating the importance score for a skill c in a presentation section i as lambda(c,i)=g (gamma (c, i), delta (c, i)), where g(.,.) is a function of two variables, such as, e.g. a convex combination, g(x, y)=r x+(1−r) y, where r is a predetermined coefficient expressing respective weights to be assigned to x and y.

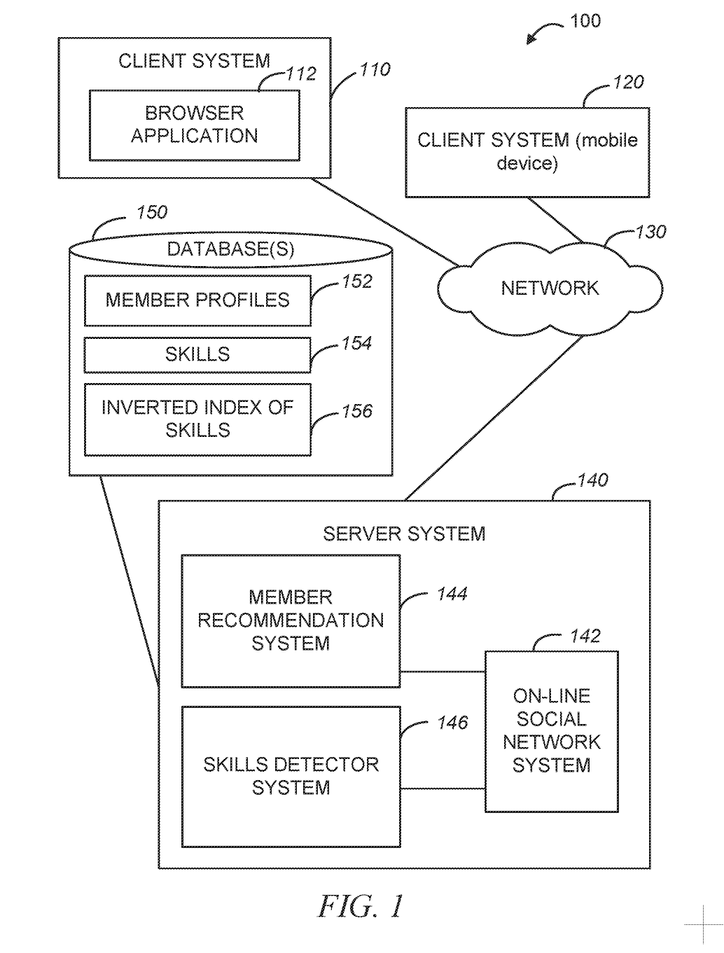

In some embodiments, the skills detector system is configured to select from the detected skills a set of most important skills in a section i, C(i) along with their corresponding importance scores calculated using one of the methodologies described above, and present it to the user. For example, the skills detector system may determine that a certain section in a subject presentation discusses two skills—“grant writing” and “proofreading” —and calculate respective importance scores for each of these skills. When that section of the subject presentation is being viewed by a user, the user can also be presented with the information regarding the skills being discussed in the section, their respective importance scores and an explanation of the importance scores (e.g., explaining that the importance scores were calculated based on the placement of the corresponding phrases within the document structure). Once the skills detector system determines the skills in each section of the presentation and their respective importance scores, this information may be stored as associated with the presentation and used, by the member recommendation system to recommend one or more educational programs or on-line connections that are relevant to one or more of these associated skills. An example member recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a member recommendation system 144 that is configured to have one or more functionalities described above. The member recommendation system 144 is configured to detect that an electronic presentation is being presented to a user on a display device, to determine skills discussed in a presentation, to determine connections that have been identified as associated with one or more skills discussed in the presentation, rank the connections based on their respective relevance values, and recommend to the user of the presentation those connections that have been assigned the highest relevance scores. The member recommendation system 144 utilizes an inverted index of skills 156, as described above.

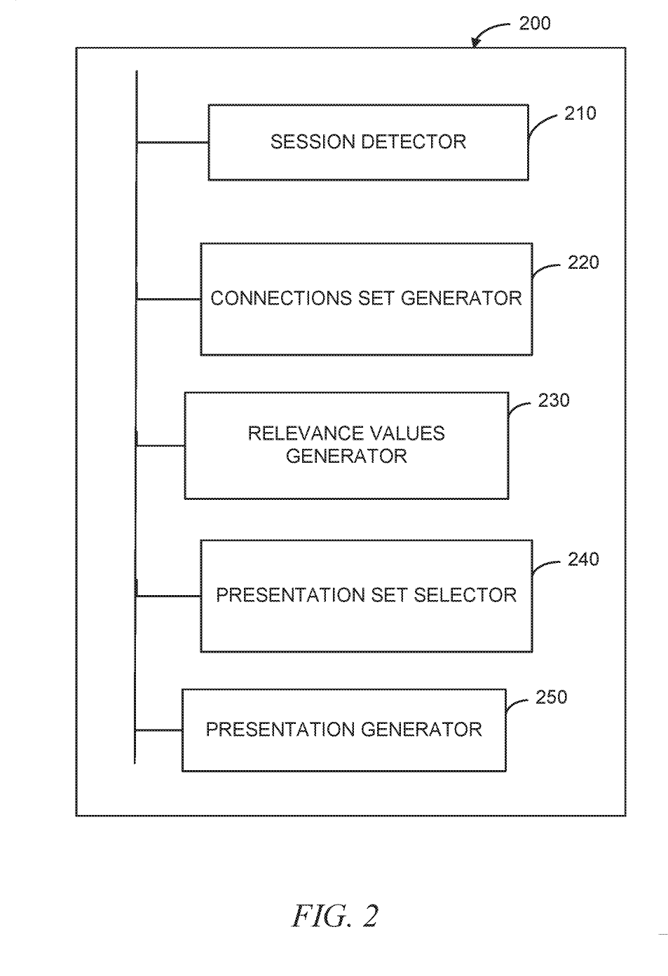

The server system 140 also hosts a skills detector system 146. The skills detector system 146 is configured to determine which skills are referenced in a presentation and generate respective importance scores of the determined skills as related to the presentation. As explained above, in order to identify a phrase that appears in a presentation as representing a skill, the skills detector system 146 determines whether the phrase is included in a skills database 154 maintained by the on-line social network system 142. The skills detector system 144 determines respective importance scores of the determined skills using any of the methodologies described above. An example member recommendation system 144 is illustrated in FIG. 2.

FIG. 2 is a block diagram of a system 200 to detect relevant connections for an electronic presentation 142 of FIG. 1. As shown in FIG. 2, the system 200 includes a session detector 210, a connections set generator 220, a relevance values generator 230, a presentation set selector 240, and a presentation generator 250. The session detector 210 is configured to detect an editing session with respect to an electronic presentation. The electronic presentation is associated with a set of skills, and the editing session is associated with a user represented by a member profile in the on-line social network system 142 of FIG. 1. Each item in the set of skills represents respective skills that correspond to respective entries in the skills database 154 of FIG. 1 maintained by the on-line social network system 142. As described above, a profile from member profiles maintained in the on-line social network system 142 includes a skills section that can be populated with one or more values corresponding to respective entries the skills database 154.

The connections set generator 220 is configured to generate a candidate set of user connections. Each item in the candidate set of user connections is a reference to a connection of the user in the on-line social network system 142 that has been identified as associated with a skill associated with the electronic presentation. In some embodiments, the connections set generator 220 utilizes the inverted index of skills 156 of FIG. 1, as discussed above. The connections set generator 220 may also be configured to generate a candidate set of user connections by examining respective skills section in the member profiles representing the user's connections and selecting those profiles that list one or more skills associated with the electronic presentation.

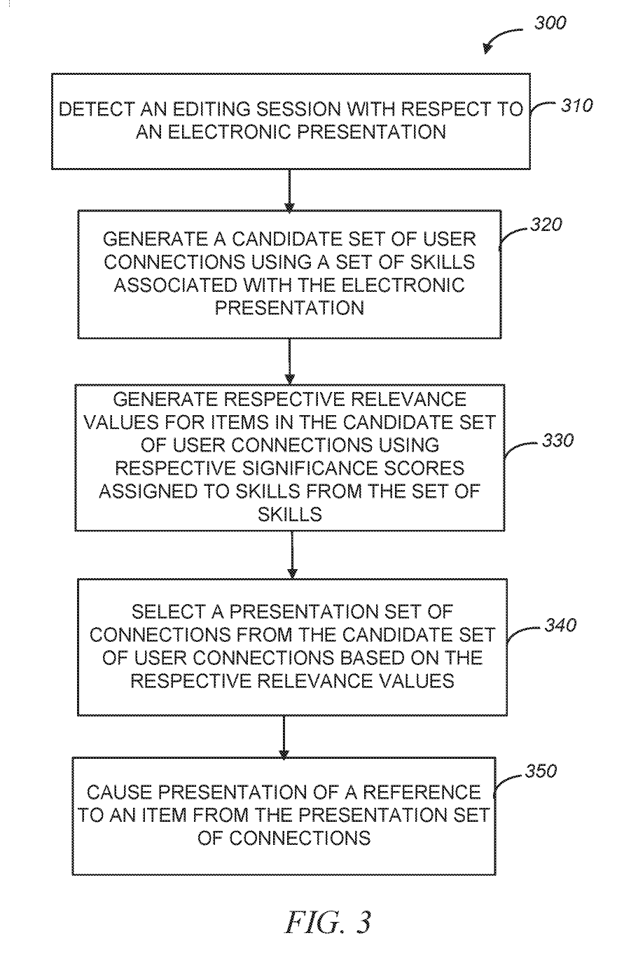

The relevance values generator 230 is configured to generate respective relevance values for items in the candidate set of user connections using respective significance scores assigned to skills from the set of skills associated with the electronic presentation. The relevance values generator 230 is configured to generate respective relevance values for items in the candidate set of user connections using respective significance scores assigned to skills from the set of skills associated with the electronic presentation. The presentation set selector 240 is configured to select a presentation set of connections from the candidate set of user connections based on the respective relevance values using any of the methodologies described above. The presentation generator 250 is configured to cause presentation, on a display device, of a reference to an item from the presentation set of connections. Some operations performed by the system 200 may be described with reference to FIG. 3.

FIG. 3 is a flowchart of a method 300 to detect relevant connections for an electronic presentation 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the session detector 210 of FIG. 2 detects detect an editing session with respect to an electronic presentation. The electronic presentation is associated with a set of skills, and the editing session is associated with a user represented by a member profile in the on-line social network system 142 of FIG. 1. Each item in the set of skills represents respective skills that correspond to respective entries in the skills database 154 of FIG. 1 maintained by the on-line social network system 142. At operation 320, the connections set generator 220 of FIG. 2 generates a candidates set of user connections, where each item in the candidate set of user connections is a reference to a connection of the user in the on-line social network system 142 that has been identified as associated with a skill associated with the electronic presentation. The relevance values generator 230 of FIG. 2 generates respective relevance values for items in the candidate set of user connections at operation 330. At operation 340, the presentation set selector 240 of FIG. 2 selects a presentation set of connections from the candidate set of user connections based on the respective relevance values using any of the methodologies described above. The presentation generator 250 of FIG. 2 causes presentation of references to one or more items from the presentation set of connections at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

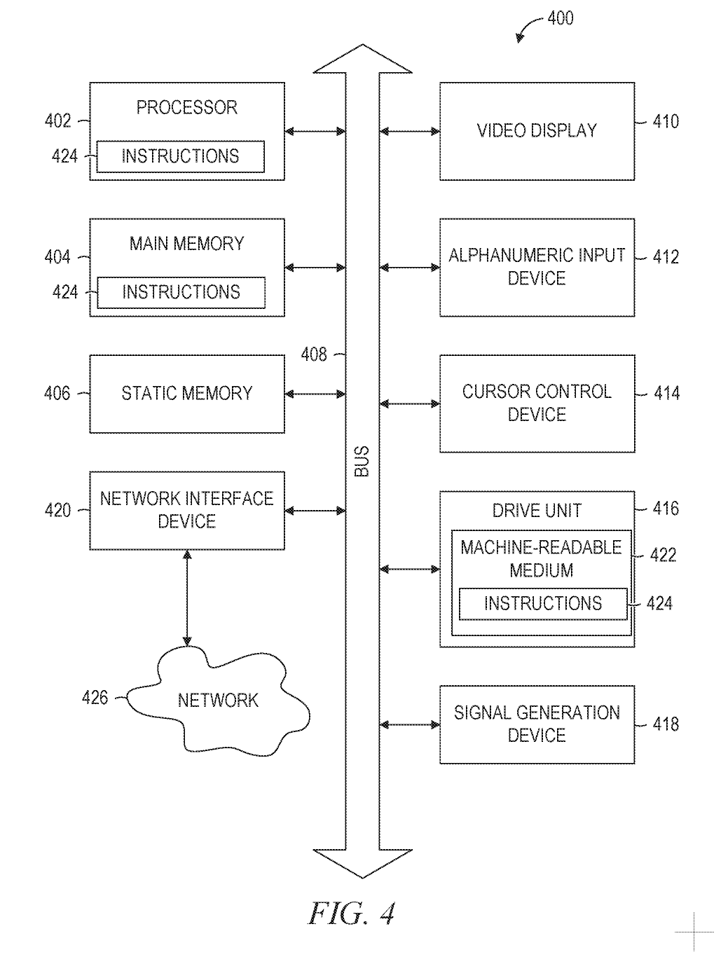

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (hTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (R BMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to identify connected member profiles that are relevant with respect to skills discussed in an electronic presentation has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
detecting an editing session with respect to an electronic presentation, the electronic presentation associated with a set of skills;
determining that the editing session is associated with a user represented by a member profile in the on-line social network system;
using at least one processor, generating a candidate set of user connections, each item in the set of user connections comprising a reference to a profile in the on-line social network system that has a link indicating connectedness with the member profile and also has a skill from the set of skills listed in a skills section of the associated profile;
generating respective relevance values for items in the candidate set of user connections using respective significance scores assigned to skills from the set of skills;
selecting a presentation set of connections from the candidate set of user connections based on the respective relevance values; and
causing presentation, on a display device, of a reference to an item from the presentation set of connections.

2. The method of claim 1, wherein the generating of a relevance value from the respective relevance values with respect to a profile from the candidate set of user connections comprises determining that the profile and the member profile are associated with a common group in the on-line social network system.

3. The method of claim 1, wherein the generating of a relevance value from the respective relevance values with respect to a profile from the candidate set of user connections comprises determining a number of electronic communications between the profile and the member profile in the on-line social network system.

4. The method of claim 1, wherein the generating of a relevance value from the respective relevance values with respect to a profile from the candidate set of user connections comprises determining one or more views in the on-line social network system, the one or more views associated with an electronic document and also with the profile and the member profile.

5. The method of claim 1, wherein the member profile representing the user the on-line social network system is associated with a set of user skills, the generating of the presentation set of connections comprises:
generating a personalized set of skills that includes those entries from the set of skills that are omitted from the set of user skills; and
using the personalized set of skills to generate the candidate set of user connections.

6. The method of claim 1, wherein each skill from the set of user skills is assigned a respective significance score, the generating of the presentation set of connections comprises:
generating a personalized importance score for each skill in the set of skills using the respective significance scores; and
generating the respective relevance values for items in the candidate set of employees using the respective significance scores.

7. The method of claim 1, comprising generating additional user interface, the additional user interface comprising an actionable control associated with the reference to activate a preview of an associated employee profile in the on-line social network system.

8. The method of claim 1, wherein the set of skills is associated with a section from a plurality of sections in the electronic presentation.

9. The method of claim 1, wherein the set of skills is associated with the entire electronic presentation.

10. The method of claim 1, wherein the electronic presentation is an electronic slide show.

11. A computer-implemented system comprising:
a session detector, implemented using at least one processor, to detect an editing session with respect to an electronic presentation, the electronic presentation associated with a set of skills, the editing session associated with a user represented by a member profile in the on-line social network system;
a connections set generator, implemented using at least one processor, to generate a candidate set of user connections, each item in the set of user connections comprising a reference to a profile in the on-line social network system that has a link indicating connectedness with the member profile and also has a skill from the set of skills listed in a skills section of the associated profile;
a relevance values generator, implemented using at least one processor, to generate respective relevance values for items in the candidate set of user connections using respective significance scores assigned to skills from the set of skills;
a presentation set selector, implemented using at least one processor, to select a presentation set of connections from the candidate set of user connections based on the respective relevance values; and
a presentation generator, implemented using at least one processor, to cause presentation, on a display device, of a reference to an item from the presentation set of connections.

12. The system of claim 11, wherein the relevance values generator is to determine that the profile and the member profile are associated with a common group in the on-line social network system.

13. The system of claim 11, wherein the relevance values generator is to determine a number of electronic communications between the profile and the member profile in the on-line social network system.

14. The system of claim 11, wherein the relevance values generator is to determine one or more views in the on-line social network system, the one or more views associated with an electronic document and also with the profile and the member profile.

15. The system of claim 11, wherein the member profile representing the user the on-line social network system is associated with a set of user skills, the presentation set generator is to:
generate a personalized set of skills that includes those entries from the set of skills that are omitted from the set of user skills; and
use the personalized set of skills to generate the candidate set of user connections.

16. The system of claim 11, wherein each skill from the set of user skills is assigned a respective significance score, the presentation set generator is to:
generate a personalized importance score for each skill in the set of skills using the respective significance scores; and
generate the respective relevance values for items in the candidate set of employees using the respective significance scores.

17. The system of claim 11, wherein the presentation generator is to generate additional user interface, the additional user interface comprising an actionable control associated with the reference to activate a preview of an associated employee profile in the on-line social network system.

18. The system of claim 11, wherein the set of skills is associated with a section from a plurality of sections in the electronic presentation.

19. The system of claim 11, wherein the set of skills is associated with the entire electronic presentation.

20. A machine-readable non-transitory storage medium having instruction data executable by a machine to cause the machine to perform operations comprising:
detecting an editing session with respect to an electronic presentation, the electronic presentation associated with a set of skills;
determining that the editing session is associated with a user represented by a member profile in the on-line social network system;
generating a candidate set of user connections, each item in the set of user connections comprising a reference to a profile in the on-line social network system that has a link indicating connectedness with the member profile and also has a skill from the set of skills listed in a skills section of the associated profile;
generating respective relevance values for items in the candidate set of user connections using respective significance scores assigned to skills from the set of skills;
selecting a presentation set of connections from the candidate set of user connections based on the respective relevance values; and
causing presentation, on a display device, of a reference to an item from the presentation set of connections.
